(19) United States
(12) Patent Application Publication
(10) Pub. No.: US 2026/0179999 A1
(43) Pub. Date: Jun. 25, 2026

(54) BATTERY MANUFACTURING DEVICE AND BATTERY MANUFACTURING METHOD

(71) Applicant: LG ENERGY SOLUTION, LTD., Seoul (KR)

(72) Inventors: Kyu Taek KANG, Daejeon (KR); Min Su KIM, Daejeon (KR); Jong Seok PARK, Daejeon (KR); June Hee KIM, Daejeon (KR); Min Kyu SIM, Daejeon (KR); Jee Yeon KOH, Daejeon (KR)

(21) Appl. No.: 19/538,735

(22) Filed: Feb. 12, 2026

Related U.S. Application Data
(63) Continuation of application No. 18/606,985, filed on Mar. 15, 2024.

(30) Foreign Application Priority Data
Aug. 8, 2023 (KR) 10-2023-0103758

(51) Int. Cl. H01M 10/04; H01M 10/48

(52) U.S. Cl. CPC H01M 10/0409; H01M 10/0431; H01M 10/049; H01M 10/48

(57) ABSTRACT

Systems and methods for manufacturing a battery are disclosed. One system may include: a first cutter configured to cut a first electrode sheet into a first electrode portion; a second cutter configured to cut a second electrode sheet into a second electrode portion having a second length; a winder configured to form an electrode assembly by winding the first electrode portion, the second electrode portion, a separator between the first electrode portion and the second electrode portion; and an identification information assigning device configured to assign identification information to the electrode assembly based on: a cut count value of the first electrode sheet and/or a cut count value of the second electrode sheet; and/or a position coordinate value of the first electrode sheet and/or a position coordinate value of the second electrode sheet.

### CROSS-REFERENCE TO RELATED APPLICATION(S)

The present application is a Continuation of U.S. patent application Ser. No. 18/606,985 filed on Mar. 15, 2024, which claims priority to Korean Patent Application No. 10-2023-0103758 filed on Aug. 8, 2023 in the Republic of Korea, the disclosures of which are incorporated herein by reference.

### TECHNICAL FIELD

The present disclosure relates to a battery manufacturing device and a battery manufacturing method.

### BACKGROUND

Unlike primary batteries, secondary batteries are capable of being charged and discharged a plurality of times. Secondary batteries are widely used as an energy source for various wireless devices such as handsets, laptops, and cordless vacuum cleaners. Recently, as the manufacturing cost per unit capacity of secondary batteries has dramatically decreased due to improvements in energy density and economies of scale, and the cruising range of battery electric vehicles (BEVs) has increased to the same level as fuel vehicles, the main uses of secondary batteries are moving from mobile devices to mobility.

Secondary batteries are manufactured through an electrode process, an assembly process, and an activation process. Among them, the electrode process is the most critical process in determining the yield and performance of battery cells. The electrode process may include a coating process, a roll pressing process, and a slitting process. In the coating process, the surface of a current collector may be coated with active materials and insulating materials. In the roll pressing process, an electrode may be pressed by pressing rolls. The roll pressing process may determine the density, performance and surface quality of the electrode. In the slitting process, the electrode may be slit into a plurality of electrodes depending on the design of the battery cell.

The background description provided herein is for the purpose of generally presenting context of the disclosure. Unless otherwise indicated herein, the materials described in this section are not prior art to the claims in this application and are not admitted to be prior art, or suggestions of the prior art, by inclusion in this section.

### SUMMARY

The present disclosure is to provide a battery manufacturing device and a battery manufacturing method with improved quality traceability in a battery manufacturing process.

Each of the aspects disclosed herein may include one or more of the features described in connection with any of the other disclosed aspects or embodiments.

In one example, a battery manufacturing system may include: a first cutter configured to cut a first electrode sheet unwound from a first electrode roll into a first electrode portion having a first length; a second cutter configured to cut a second electrode sheet unwound from a second electrode roll into a second electrode portion having a second length; a winder configured to form an electrode assembly by winding the first electrode portion, the second electrode portion, a separator between the first electrode portion and the second electrode portion; and an identification information assigning device configured to assign identification information to the electrode assembly based on: a cut count value of the first electrode sheet and/or a cut count value of the second electrode sheet; and/or a position coordinate value of the first electrode sheet and/or a position coordinate value of the second electrode sheet.

In other aspects, the system may include one or more of the following features. The system further including: a first notching device configured to notch the first electrode sheet unwound from the first electrode roll; and a second notching device configured to notch the second electrode sheet unwound from the second electrode roll. The system further including a position measurement device configured to generate a first position signal of the first electrode sheet moving from the first electrode roll to the winder and a second position signal of the second electrode sheet moving from the second electrode roll to the winder. Coordinate data including the position coordinate values may be acquired based on the first position signal and the second position signal. At least one first electrode inspection and/or measurement device may be provided between the first electrode roll and the winder. At least one second electrode inspection and/or measurement device may be provided between the second electrode roll and the winder. The identification information assigning device may include: a process controller configured to control one or more process equipment devices provided between the first electrode role and the winder and between the second electrode roll and the winder; an identification information management server; or a combination of the process controller and the identification information management server. The process controller and/or the identification information management server may manage the identification information of the electrode assembly based on process event data. The process event data may be acquired when the first electrode sheet moves from the first electrode roll to the winder and when the second electrode sheet moves from the second electrode roll to the winder. The system may further include a roll map generation server configured to generate a first electrode roll map and a second electrode roll map. The first electrode roll map may be a simulated first electrode sheet comprising a first coordinate value indicating a position of the first electrode sheet moving from the first electrode roll to the winder. The first electrode roll map may include: first process event data acquired based on a movement of the first electrode sheet; the second electrode roll map that may be a simulated second electrode sheet comprising a second coordinate value indicating a position of the second electrode sheet moving from the second electrode roll to the winder; and the second electrode roll map second process event data acquired based on a movement of the second electrode sheet. The identification information assigning device may be coupled to the roll map generation server. The identification information assigning device and/or the roll map generation server may be configured to relate the identification information of the electrode assembly to at least one of the first coordinate value, the second coordinate value, the first process event data, or the second process event data.

In another example, a battery manufacturing system may be provided. The system may include: a first cutter configured to cut a first electrode sheet unwound from a first electrode roll into a first electrode portion having a first length; a second cutter configured to cut a second electrode sheet unwound from a second electrode roll into a second electrode portion having a second winding length; a winder configured to form an electrode assembly by winding the first electrode portion, the second electrode portion, and a separator between the first electrode portion and the second electrode portion; and a roll map generation server configured to generate a first electrode roll map and a second roll map. The first roll map may include a simulated first electrode sheet comprising: a first coordinate value indicating a position of the first electrode sheet moving from the first electrode roll to the winder; and first process event data acquired based on a movement of the first electrode sheet. The second electrode roll map may include: a simulated second electrode sheet comprising a second coordinate value indicating a position of the second electrode sheet moving from the second electrode roll to the winder; and second process event data acquired based on a movement of the second electrode sheet.

In other aspects, the system may include one or more of the following features. The system may further include: a first notching device configured to notch the first electrode sheet unwound from the first electrode roll; and a second notching device configured to notch the second electrode sheet unwound from the second electrode roll. The system may further include an identification information assigning device configured to assign identification information to the electrode assembly based on: a cut count value of the first electrode sheet and/or a cut count value of the second electrode sheet; or a first coordinate value of the first electrode sheet and/or a second coordinate value of the second electrode sheet. The identification information assigning device may be coupled to the roll map generation server, and the identification information assigning device or the roll map generation server may be configured to relate the identification information of the electrode assembly to at least one of the first coordinate value, the second coordinate value, the first process event data, or the second process event data.

In yet another example, a method of manufacturing a battery may be provided. The method may include: a first electrode sheet unwound from a first electrode roll may be cut into a first electrode portion having a first winding length; a second electrode sheet unwound from a second electrode roll may be cut into a second electrode portion having a second winding length; an electrode assembly may be formed by winding the first electrode portion, the second electrode portion, and a separator between the first electrode portion and the second electrode portion; and identification information may be assigned to the electrode assembly based on: a cut count value of the first electrode sheet and/or a cut count value of the second electrode sheet, and/or a position coordinate value of the first electrode sheet and/or a position coordinate value of the second electrode sheet.

In other aspects, the method of manufacturing a battery may include one or more of the following features or steps. The method may further include, prior to the cutting of the first electrode sheet and the second electrode sheet, performing a notching process to form one or more electrode tabs on the first electrode sheet and the second electrode sheet. The notching process of the first electrode sheet is performed within the first length. The notching process of the second electrode sheet is performed within the second length. The separator may include a third length. The third length may be greater than the first length and the second length. The identification information of the electrode assembly may include: 1) lot identification information of the first electrode sheet and/or lot identification information of the second electrode sheet; 2) data regarding defects of the first electrode sheet and/or the second electrode sheet; 3) data regarding defects of the electrode assembly; 4) tray identification information of a tray on which the electrode assembly is loaded; 5) position data of a loading position of the electrode assembly in the tray; and 6) can identification information of an electrode can in which the electrode assembly is accommodated. The position coordinate value of the first electrode sheet may include at least one of a start coordinate value of the first length or an end coordinate value of the first length, or the position coordinate value of the second electrode sheet may include at least one of a start coordinate value of the second length or an end coordinate value of the second length. The position coordinate value of the first electrode sheet may be included in a first electrode roll map and the position coordinate value of the second electrode sheet may be included in a second electrode roll map. The first electrode roll map may include a simulated first electrode sheet moving from the first electrode roll to a winder. The second electrode roll map may be a simulated second electrode sheet moving from the second electrode roll to the winder. The identification information of the electrode assembly may be further related to process event data acquired when the first electrode sheet moves from the first electrode roll to a winder and when the second electrode sheet moves from the second electrode roll to the winder. The process event data may include: equipment data acquired from one or more process equipment devices between the first electrode roll to the winder and the second electrode roll to the winder; inspection and/or measurement data acquired in the one or more processes; and time series data acquired in the one or more processes.

In yet another example, one or more non-transitory computer-readable media comprising instructions for manufacturing a battery may be provided. The instructions are capable of being performed on a processor and the instructions may include: cutting a first electrode sheet unwound from a first electrode roll into a first electrode portion having a first winding length; cutting a second electrode sheet unwound from a second electrode roll into a second electrode portion having a second winding length; forming an electrode assembly by winding the first electrode portion, the second electrode portion, and a separator between the first electrode portion and the second electrode portion; and assigning identification information to the electrode assembly based on: a cut count value of the first electrode sheet and/or a cut count value of the second electrode sheet, and/or a position coordinate value of the first electrode sheet and/or a position coordinate value of the second electrode sheet.

In other aspects, the one or more non-transitory computer-readable media may include one or more of the following features or steps: prior to the cutting of the first electrode sheet and the second electrode sheet, performing a notching process to form one or more electrode tabs on the first electrode sheet and the second electrode sheet. The notching process of the first electrode sheet is performed within the first length. The notching process of the second electrode sheet is performed within the second length.

In yet another example, a battery may be provided. The battery may include: a housing; a first electrode comprising a first indicator, the first indicator corresponding with a first a cut count value of a first electrode sheet; a second electrode comprising a second indicator, the second indicator corresponding with a position coordinate value of a second electrode sheet; and a separator between the first electrode and the second electrode. The first electrode, the second electrode, and the separator may form an electrode assembly, the electrode assembly being accommodated in the housing. The electrode assembly may include a third indicator, the third indicator comprising identification information of the electrode assembly. The housing may include a fourth indicator, the fourth indicator corresponding with the third indicator. The first indicator may be a marking on a surface of the first electrode. The first electrode may include an uncoated portion of the first electrode sheet. The fourth indicator may correspond with identification information of the housing. The second pattern may include a coated portion of the second electrode sheet. The separator may include a fifth indicator. The fifth indicator may be a marking on a surface of the separator.

In order to solve the aforementioned problem, according to an exemplary embodiment, there is provided a battery manufacturing device including a first cutter configured to cut a first electrode sheet unwound from a first electrode roll by a first winding length, a second cutter configured to cut a second electrode sheet unwound from a second electrode roll by a second winding length, a winder configured to manufacture an electrode assembly by winding the first electrode sheet of the first winding length and the second electrode sheet of the second winding length with a separator interposed therebetween, and an identification information assigning device configured to assign identification information to the electrode assembly based on at least one of i) and ii) below,

a cut count value of the first electrode sheet and/or a cut count value of the second electrode sheet, and/or

ii) a position coordinate value of the first electrode sheet corresponding to the first winding length and/or a position coordinate value of the second electrode sheet corresponding to the second winding length.

According to the exemplary embodiment, the battery manufacturing device may further include a first notching device configured to notch the first electrode sheet unwound from the first electrode roll and a second notching device configured to notch the second electrode sheet unwound from the second electrode roll.

According to the exemplary embodiment, the battery manufacturing device may further include a position measurement device configured to generate a position signal of the first electrode sheet moving from the first electrode roll to the winder and a position signal of the second electrode sheet moving from the second electrode roll to the winder, and coordinate data including the position coordinate values may be acquired based on the position signals.

According to the exemplary embodiment, the battery manufacturing device may include at least one first electrode inspection and/or measurement device between the first electrode roll and the winder and at least one second electrode inspection and/or measurement device between the second electrode roll and the winder.

The identification information assigning device may be a process controller configured to control each process equipment from the first and second electrode rolls to the winder, an identification information management server data-communicably connected to the process controller, or a combination of the process controller and the identification information management server.

The process controller and/or the identification information management server may manage the identification information about the electrode assembly with process event data acquired when the first electrode sheet moves from the first electrode roll to the winder and when the second electrode sheet moves from the second electrode roll to the winder.

According to the exemplary embodiment, the battery manufacturing device may further include a roll map creation server configured to create each of a first electrode roll map that is a simulated electrode in which a first coordinate value indicating a position of the first electrode sheet moving from the first electrode roll to the winder and the process event data acquired according to the movement of the first electrode sheet are represented in relation and a second electrode roll map that is a simulated electrode in which a second coordinate value indicating a position of the second electrode sheet moving from the second electrode roll to the winder and the process event data acquired according to the movement of the second electrode sheet are represented in relation.

The identification information assigning device may be data-communicably connected to the roll map creation server, and the identification information assigning device or the roll map creation server may relate the identification information about the electrode assembly to at least one of the first and second coordinate values and the process event data included in the first and second electrode roll maps.

According to an exemplary embodiment, there is provided a battery manufacturing device including a first cutter configured to cut a first electrode sheet unwound from a first electrode roll by a first winding length, a second cutter configured to cut a second electrode sheet unwound from a second electrode roll by a second winding length, a winder configured to manufacture an electrode assembly by winding the first electrode sheet of the first winding length and the second electrode sheet of the second winding length with a separator interposed therebetween, and a roll map creation server configured to create each of a first electrode roll map that is a simulated electrode in which a first coordinate value indicating the position of the first electrode sheet moving from the first electrode roll to the winder and process event data acquired according to the movement of the first electrode sheet are represented in relation and a second electrode roll map that is a simulated electrode in which a second coordinate value indicating the position of the second electrode sheet moving from the second electrode roll to the winder and process event data acquired according to the movement of the second electrode sheet are represented in relation.

According to the exemplary embodiment, the battery manufacturing device may further include a first notching device configured to notch the first electrode sheet unwound from the first electrode roll and a second notching device configured to notch the second electrode sheet unwound from the second electrode roll.

According to the exemplary embodiment, the battery manufacturing device may include an identification information assigning device configured to assign identification information to the electrode assembly based on at least one of i) and ii) below,
i) a cut count value of the first electrode sheet and/or a cut count value of the second electrode sheet, and/or
ii) a first coordinate value of the first electrode sheet corresponding to the first winding length and/or a second coordinate value of the second electrode sheet corresponding to the second winding length.

The identification information assigning device may be data-communicably connected to the roll map creation server, and the identification information assigning device or the roll map creation server may relate the identification information about the electrode assembly to at least one of the first and second coordinate values and the process event data included in the first and second electrode roll maps.

According to another exemplary embodiment, there is provided a battery manufacturing method including cutting a first electrode sheet unwound from a first electrode roll by a first winding length, and cutting a second electrode sheet unwound from a second electrode roll by a second winding length, manufacturing an electrode assembly by winding the first electrode sheet of the first winding length and the second electrode sheet of the second winding length with a separator interposed therebetween, and assigning identification information to the electrode assembly based on at least one of i) and ii) below,
i) a cut count value of the first electrode sheet and/or a cut count value of the second electrode sheet, and/or
ii) a position coordinate value of the first electrode sheet corresponding to the first winding length and/or a position coordinate value of the second electrode sheet corresponding to the second winding length.

The battery manufacturing method may further include, prior to the cutting of the first electrode sheet and the second electrode sheet, performing notching processing to form electrode tabs on the first electrode sheet and the second electrode sheet, respectively, a notching processing portion of the first electrode sheet may be included within the first winding length, and a notching processing portion of the second electrode sheet may be included within the second winding length.

The first electrode sheet of the first winding length and the second electrode sheet of the second winding length may be manufactured into the electrode assembly by being wound together with a separator of the third winding length.

The identification information about the electrode assembly may be related to one or more of the following,
1) lot identification information about the first electrode sheet and/or lot identification information about the second electrode sheet,
2) a cut count value of the first electrode sheet and/or a cut count value of the second electrode sheet,
3) a position coordinate value of the first electrode sheet corresponding to the first winding length and/or a position coordinate value of the second electrode sheet corresponding to the second winding length,
4) data on defects of the first electrode sheet and/or the second electrode sheet,
5) data on defects of the electrode assembly,
6) tray identification information about a tray on which the electrode assembly is loaded,
7) data on a loading position of the electrode assembly in the tray, and
8) can identification information about an electrode can in which the electrode assembly is accommodated.

The position coordinate value of the first electrode sheet may include at least one of a start coordinate value and an end coordinate value of the first winding length, or the position coordinate value of the second electrode sheet may include at least one of a start coordinate value and an end coordinate value of the second winding length.

The position coordinate values of the first electrode sheet and the second electrode sheet may be roll map coordinate values included in a first electrode roll map that is a simulated electrode imitating the first electrode sheet moving from the first electrode roll to a winder and a second electrode roll map that is a simulated electrode imitating the second electrode sheet moving from the second electrode roll to the winder.

The identification information about the electrode assembly may be further related to process event data acquired when the first electrode sheet moves from the first electrode roll to a winder and when the second electrode sheet moves from the second electrode roll to the winder.

The process event data may include at least one of equipment data acquired from each process equipment from the first and second electrode rolls to the winder, process-related inspection and/or measurement data acquired in each process, and time series data acquired in each process.

According to exemplary embodiments of the present disclosure, identification information (ID) can be assigned to an electrode assembly manufactured in a winding process. Thereby, it is possible to prevent occurrence of a gray zone in which the electrode assembly cannot be traced between the winding process and a following process of the winding process.

In addition, according to the exemplary embodiments of the present disclosure, coordinate values indicating the position of an electrode to be wound in the winding process can be acquired and the coordinate values can be related to the identification information. Thereby, it is possible to easily trace the quality of electrodes processed in the winding process and an electrode process before the winding process.

In addition, according to the exemplary embodiments of the present disclosure, identification information on an electrode assembly included in, for example, a cylindrical battery or a prismatic battery can be acquired, and the identification information can be matched to identification information about a workpiece (e.g., electrode), an intermediate product, or a product before and after the winding process. Thereby, it is possible to easily perform quality control and quality tracing throughout the entire battery manufacturing process.

The effects that can be obtained from exemplary embodiments of the present disclosure are not limited to the effects mentioned above, and other effects not mentioned can be clearly derived and understood by those skilled in the art to which exemplary embodiments of the present disclosure pertain from the following description. That is, unintended effects resulting from implementing exemplary embodiments of the present disclosure can also be derived by those skilled in the art from the exemplary embodiments of the present disclosure.

### BRIEF DESCRIPTION OF THE DRAWINGS

The accompanying drawings illustrate a preferred embodiment of the present disclosure and together with the foregoing disclosure, serve to provide further understanding of the technical features of the present disclosure, and thus, the present disclosure is not construed as being limited to the drawings.

FIG. 1 shows a battery manufacturing system according to an exemplary embodiment.

FIG. 2 shows a battery manufacturing device according to an exemplary embodiment.

FIG. 3 is a schematic diagram showing that an electrode and a separator are wound by a winder at a predetermined length.

FIG. 4 shows that identification information about an electrode assembly is related to other information according to the exemplary embodiment.

FIG. 5 shows a battery manufacturing device according to an exemplary embodiment.

FIG. 6 is a flowchart for describing a battery manufacturing method according to an exemplary embodiment.

FIG. 7 is a flowchart for describing another battery manufacturing method according to an exemplary embodiment.

### DETAILED DESCRIPTION

Hereinafter, preferred embodiments of the present disclosure will be described in detail with reference to the accompanying drawings. Prior to the description, terms or words used in this specification and claims should not be restrictively interpreted as ordinary meanings or dictionary-based meanings, but should be interpreted as meanings and concepts conforming to the technical aspects of the present disclosure on the basis of the principle that an inventor is allowed to properly define concepts of terms to describe his or her disclosure in the best ways.

Therefore, embodiments described in the specification and configurations shown in the drawings are merely the most preferred embodiment of the present disclosure, and, not intended to fully describe the technical aspects of the present disclosure, so it should be understood that a variety of other equivalents and modifications could be made thereto at the time of filing the application.

Furthermore, in describing the present disclosure, when it is determined that the detailed description of the related known technology or function may obscure the subject matter of the present disclosure, the detailed description thereof will be omitted.

Since embodiments of the present disclosure are provided to more completely describe the present disclosure to those skilled in the art, the shapes, sizes, or the like of components in the drawings may be exaggerated, omitted, or schematically shown for clearer description. Therefore, the size or ratio of each component does not entirely reflect the actual size or ratio.

An embodiment or implementation described herein as “exemplary” is not to be construed as preferred or advantageous, for example, over other embodiments or implementations; rather, it is intended to reflect or indicate that the embodiment(s) is/are “example” embodiment(s). Subject matter can be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of exemplary embodiments in whole or in part.

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section. Both the foregoing general description and the following detailed description are exemplary and explanatory only and are not restrictive of the features, as claimed.

In this disclosure, the term “based on” means “based at least in part on.” The terms including the ordinal number such as “first”, “second” and the like, may be used to distinguish one element from another among various elements, but not intended to limit the elements by the terms. The singular forms “a,” “an,” and “the” include plural referents unless the context dictates otherwise. The term “exemplary” is used in the sense of “example” rather than “ideal.” The term “or” is meant to be inclusive and means either, any, several, or all of the listed items. The terms “comprises,” “comprising,” “includes,” “including,” or other variations thereof, are intended to cover a nonexclusive inclusion such that a process, method, or product that comprises a list of elements does not necessarily include only those elements, but may include other elements not expressly listed or inherent to such a process, method, article, or apparatus. Relative terms, such as, “substantially” and “generally,” are used to indicate a possible variation of ±5% of a stated or understood value.

In addition, throughout the specification, when a portion is referred to as being “connected” or “coupled” to another portion, it is not limited to the case that they are “directly connected” or “directly coupled”, but it also includes the case where they are “indirectly connected” or “indirectly coupled” with one or more elements being arranged between them. In this disclosure, “and/or” is defined to include both conjunctive and disjunctive options. For example, A and/or B may be interpreted to include both “A and B” and “A or B.”

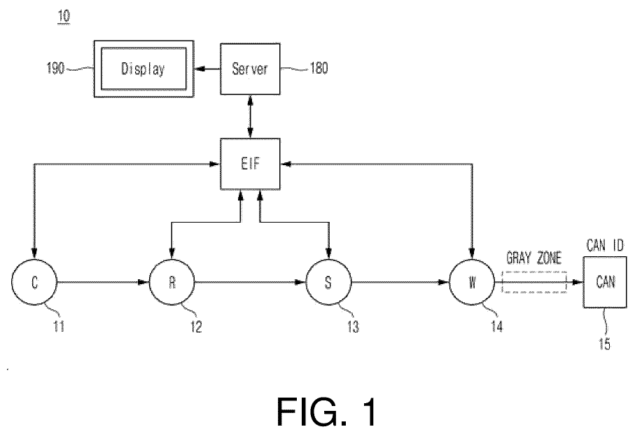

FIG. 1 shows a battery manufacturing system 10 according to an exemplary embodiment.

Referring to FIG. 1, the battery manufacturing system 10 may include a coating device 11, a roll pressing device 12, a slitting device 13, a winding device 14, an intermediate server (EIF), a server 180, and a display device 190.

The battery manufacturing system 10 may be configured to manufacture a battery cell (e.g., a cylindrical battery cells, a pouch-type battery cell, a prismatic battery cell, etc.) by performing a series of roll-to-roll processes. The electrode sheet unwound from the input electrode roll may be processed by any one of a die coater of the coating device 11, pressing rolls of the roll pressing device 12, and a slitting knife of the slitting device 13, and the processed electrode sheet may be wound into an electrode roll. Accordingly, the processes of the coating device 11, the roll pressing device 12, and the slitting device 13 for the production of battery electrodes may be referred to as the roll-to-roll processes. The winding device 14 may wind a first electrode sheet (e.g., a negative electrode sheet) unwound from a first electrode roll (e.g., a negative electrode roll), a second electrode sheet (e.g., a positive electrode sheet) unwound from a second electrode roll (e.g., a positive electrode roll), and separator sheets unwound from separator rolls together. Accordingly, the process performed by the winding device 14 may also be referred to as the roll-to-roll process.

The coating device 11 may perform the coating process on the electrode sheet. The coating process may coat an electrode slurry on the electrode sheet. The electrode slurry may include an active material, a conductive material, a binder, and a solvent. An electrode slurry may be provided by dissolving the active material, the conductive material, the binder, or the like, in the solvent.

The roll processing device 12 may perform the roll pressing process on the electrode sheet. In the roll pressing process, the electrode sheet coated with the electrode slurry may be passed between pressing rolls. The roll pressing process may flatten the surface of the electrode sheet and enhance the bonding strength between the active material of the electrode sheet and the current collector.

The slitting device 13 may perform the slitting process on the electrode sheet. The electrode sheet may be separated into a plurality of electrode sheets by the slitting process.

The winding device 14 may wind the positive electrode sheet, the negative electrode sheet, and the separator interposed therebetween and separate them after reaching a winding target length, thereby providing an electrode assembly of a cylindrical battery cell (e.g., a jelly roll-type electrode assembly).

The intermediate server (EIF) may be a device for communication between process controllers of a manufacturing facility and the server 180. The EIF and the server 180 may be located at the manufacturing facility or on a remote location. A process controller of the coating device 11, a process controller of the roll pressing device 12, a process controller of the slitting device 13, and a process controller of the winding device 14 may be coupled to each other and may communicate with the server 180 directly or indirectly through the intermediate server (EIF) or other components. For example, as needed, each process controller may communicate directly with the server 180. Accordingly, data for process events occurring in the coating device 11, the roll pressing device 12, the slitting device 13, and the winding device 14 may be transmitted to the server 180.

The server 180 may be configured to generate a roll map containing the process event data. Data of the roll map may include data representing process events and coordinate values matched to the data. The coordinate values may represent positions on electrodes. Accordingly, the roll map enables feedback, feed forward, and battery manufacturing process tracing, which will be described below. The server 180 may transmit a visualization command (VC) to the display device 190, and the display device 190 may visualize the roll map and display the visualized roll map.

In one embodiment, the roll map may be displayed on a display device including a two-dimensional graphical interface or a three-dimensional graphical interface. For example, the roll map may be displayed on one or more mobile or stationary display devices (e.g., computer monitor, laptop screen, touchscreen, tablet, mobile phone, etc.). Additionally or alternatively, the display device may include a wearable display device (e.g., head-mounted display) for displaying the roll map as a virtual reality or an augmented reality content on a graphical interface.

The roll map may be generated on a lot basis. A lot is a production unit in the roll-to-roll process, and an electrode roll that is separated after achieving the target winding length for each process is an example of the lot. Likewise, an electrode roll loaded on an unwinder of each process are also an example of the lot. The server 180 may generate and store a roll map of each process (e.g., the coating process, the roll pressing process, or the slitting process).

In the roll map, time series data constructed over time (that is, according to the progress of the process) may be related to coordinate data collected based on the amount of movement of the electrode sheet (that is, one of a consumption amount or input amount).

Battery manufacturing may involve a series of different processes or stages of manufacturing, and a leading process or stage may affect a following or subsequent process or stage. In this case, when the time series data from the leading process does not directly match a workpiece, an intermediate product, and a product in the real world, it is difficult to reflect the time series data from the leading process on the following process. Hereinafter, correction of the following or subsequent process based on data generated according to results of the leading or prior process or stage is referred to as feed forward.

In the present disclosure, the workpiece may be defined as an article provided as a result of each process, such as an electrode sheet on which the coating process, the roll pressing process, and the slitting process have been performed. The intermediate product may be defined as one of separators, electrodes, and assemblies thereof cut through a notching process. The intermediate product may also be defined as a structure including a housing and an electrode assembly built into the housing (in some cases, the structure further includes an electrolyte). The product may be defined as an article that has been processed to operate as a battery through an activation process. The above-mentioned definitions of the workpiece, intermediate product, and product refer to one aspect thereof and do not exclude other definitions known by one of ordinary skill in the art.

Because process events generally occur as the processes or stages progress, the process event data related to process events may include time series data. For example, a process controller for each process or stage may control the overall flow of each process. Therefore, events that occur according to a time flow of the process or a point in time of data occurrence may be acquired. That is, data on process events may include a value representing an event and a time value matched thereto. Accordingly, the data on process events may include time series data acquired in each process or stage.

In addition, the process event data may include equipment data acquired from each process equipment. The equipment data may be acquired from each process controller for controlling each process. The process controller(s) may be a control device used for maintenance, management, automatic control, and monitoring of a process system in each process such as each sub process (e.g., the coating process, the roll pressing process, and slitting process), an assembly process of an electrode process (e.g., an electrode stacking process or winding process), an activation process, and a module/pack process. A process programmable logic controller(s) (PLC) may be used as the process controller(s).

The process controller(s) may control equipment related to each process, such as driving of a motor required to move electrodes, motor rotation speed, and the like. Alternatively, the process controller(s) may manage process parameters required for each process. As exemplary process parameters, electrode drying temperature and/or electrode temperature may be managed in the coating process, and roll pressing pressure and the like may be adjusted in the roll pressing process. Therefore, equipment data may include various process parameter data managed by the process controller in each process.

In addition, the process event data may include process-related inspection and/or measurement data acquired in each process. For example, in the coating process, an electrode slurry loading amount may be measured or a reference point marked on the electrode may be measured. In the roll pressing process, the thickness of the electrode after roll pressing may be measured. In addition, an appearance inspection machine (e.g., a vision inspection machine) may be employed in the coating process, roll pressing process, and slitting process. Inspection and/or measurement data includes all data inspected or measured by a specified inspection device, measurement device, or inspection and measurement device in each process. In other words, the inspection and/or measurement data may include work results and/or test results performed in each process.

The process event data may be generated according to the progress of various processes performed on the electrode, and the process event data may be acquired for each individual process.

For feed forward, time series data may be related to positions of workpieces, parts, intermediate products, and products in the real world. Here, the feed forward may include controlling processing of the electrode sheet based on the roll map generated in the leading process. The roll map may be a type of simulated electrode obtained by imitating a moving real electrode (for example, a real electrode moving between the unwinder and a rewinder). The roll map may include information or data relating to time series data to coordinate data containing coordinate values representing positions of the workpieces, parts, intermediate products, and products in the real world. The roll map may provide matching of time series data with the workpieces, parts, intermediate products, and products in the real world based on the coordinate data. Accordingly, creation of the roll map and feed forward based on the roll map may enhance productivity and quality by quantifying and objectifying aspects of processes that depend on an operator's discretion.

In addition, a roll map of a leading lot may be used to improve a process for a following lot, and this operation may be referred to as process feedback. The process feedback using the roll map may include identifying a process condition and a process parameter that cause a problem and a defect based on data included in the roll map.

Furthermore, the roll map is cumulatively created for workpieces, parts, intermediate products and products of unit processes, thereby making it possible to trace a process history for shipped products (e.g., battery cells, battery modules or battery packs). As one example, a battery cell may include identification information (ID) assigned to an electrode assembly or case. The ID may include a lot number and coordinate information of electrodes and separators included in the battery cell. In other words, the ID may be related to the roll map of electrodes and separators included in the battery cell. Accordingly, when an event such as a quality issue occurs in a battery cell that has already been shipped, historical data on the manufacturing of the battery cell may be retrieved based on the ID. In one embodiment, the roll map may be displayed on a display device including a two-dimensional graphical interface or a three-dimensional graphical interface. In one embodiment, the roll map may include various data collected during manufacturing of an electrode and/or a battery. Additionally or alternatively, the roll map may include data associated with the electrode manufacturing process in accordance with the present disclosure. For example, the data may be displayed on a display device discussed above or may be stored in one or more servers (e.g., server 180) for processing and tracking.

According to exemplary embodiments, the server 180 may be a data processing system that supports various activities necessary to manage battery manufacturing, such as work schedule management, work instructions, quality control, and work performance tally. The server 180 may be, for example, a manufacturing execution system (MES). The server 180 may be configured to perform input, processing, output, and communication of data required for electrode manufacturing, such as the coating process, the press process, and manufacturing process.

According to other exemplary embodiments, the server 180 may be configured to store and process raw measurement data. The server 180 may manage the quality of processing of the electrode sheet by continuously monitoring the processing of the electrode sheet based on the measurement data. According to exemplary embodiments, the server 180 may be a statistical process controller (SPC). By collecting and analyzing manufacturing data in almost real time, the server 180 may identify problem conditions in a timely manner and provide alerts to the operator before potential problems occur.

According to other exemplary embodiments, the server 180 may be, for example, a data warehouse and may store the roll map for a long period of time based on the quality assurance period of the product or the like.

According to other exemplary embodiments, the server 180 may perform all functions of MES, SPC, and data warehouse, or may be provided separately from MES, SPC, and data warehouse to create the roll map.

Still referring to FIG. 1, the electrode assembly manufactured by being wound in the winding device 14 may be transferred and accommodated in a case such as a can or a housing. The can or housing may include any suitable shape for accommodating the electrode assembly of the present disclosure. Accordingly, can and housing may be used interchangeably in this disclosure. A can ID, which may be separate can identification information, may be assigned to the can, and the can ID may be a type of battery cell ID. Accordingly, the historical data on the manufacturing of the battery cell may be retrieved based on the can ID.

However, before the electrode assembly is accommodated in the can, in terms of logistics flow, a plurality of electrode assemblies may be accommodated and stored in a tray, or the tray may be transported and transferred to the can. When a plurality of electrode assemblies are mixed up during this process, it may be difficult to identify what material (electrode, separator, or the like) the electrode assembly accommodated in the can is made of even when the can ID is assigned during the can manufacturing process. That is, a gray zone where the electrode assembly may not be traced occurs between the winding process and the can manufacturing process. Accordingly, even when process event data or coordinate data related to the electrode of each sub-process is secured by generating the roll map in each sub-process before the winding process, in various processes between each sub-process and the can manufacturing process, it is not possible to trace the corresponding data in relation to the electrodes or the like provided in the electrode assembly.

According to the technical idea of the present disclosure, in order to prevent the gray zone from occurring, identification information (ID) may be assigned to the electrode assembly manufactured in the winding process. The identification information may be assigned based on cut count values and/or coordinate values of electrodes included in the electrode assembly.

According to another technical idea of the present disclosure, a roll map that imitates or simulates the movement of the electrode moved in the winding process may be generated.

In one embodiment, the winding process may refer to a process in which electrodes and separators are wound by a winder. In one embodiment, the winding process may include all processes in which electrode sheets and separator sheets unwound from electrode rolls and separator rolls are processed and cut and wound in the winder. That is, the unwinding process, (notching) processing process, inspection and/or measurement process, cutting process, and winding process in the winder may all be included in the winding process. In one embodiment, the roll map may be created or generated to imitate or simulate the electrode moving during the winding process.

The roll map of the winding process may include coordinate data including the coordinate value of each electrode moving during the winding process, and process event data. The identification information about the electrode assembly may be related to electrode coordinate data and process event data. The coordinate data and process event data about each electrode input into the winding process may be compared with roll map data (coordinate data and process event data) in each process generated in each sub-process before the winding process. That is, since coordinate data is assigned to the electrodes in various sub-processes, which are leading processes, and electrodes in the winding process, which is a following process, respectively, changes in the quality of or historical data related to the manufacture of electrodes that have gone through leading and following processes may be retrieved by comparing the corresponding coordinate data.

Furthermore, the identification information about the electrode assembly may be related to pieces of data acquired in a following process after the winding process (e.g., data related to a tray on which the electrode assembly is loaded, can ID, or the like). Therefore, since pieces of data related to each electrode assembly may be retrieved between the winding process and a following process based on the identification information, the quality may be easily traced between the winding process and the following process.

In conclusion, through the identification information about the electrode assembly, all historical data related to the quality or manufacture of the electrode may be traced throughout the winding process and all leading and following processes. Accordingly, process management and quality control may be efficiently carried out throughout the entire battery manufacturing process, and more reliable battery manufacturing is possible.

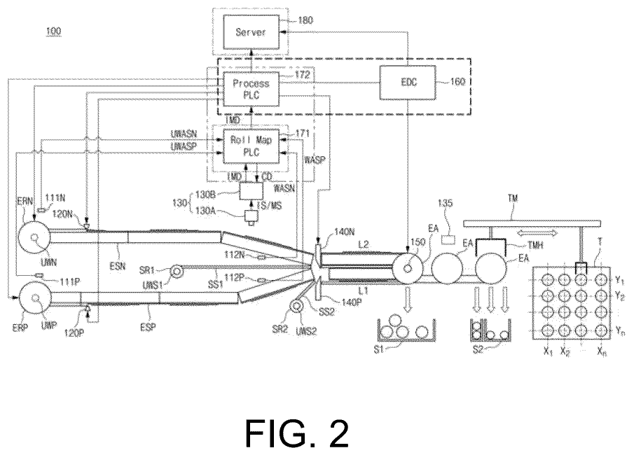

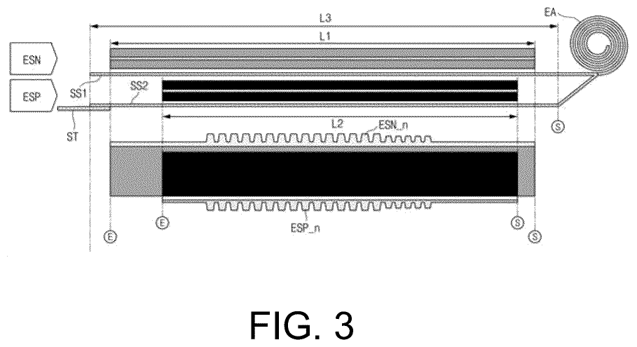

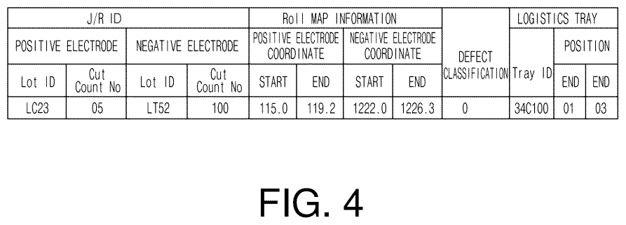

FIG. 2 shows a battery manufacturing system or device according to an exemplary embodiment, FIG. 3 is a schematic diagram showing an electrode and a separator that are wound by a winder at a predetermined length, and FIG. 4 shows an example in which identification information about an electrode assembly is related to other information according to the exemplary embodiment.

Referring to FIG. 2, a battery manufacturing system or device 100 may include unwinders UWN, UWP, UWS1, and UWS2, position measurement devices 111N, 111P, 112N, and 112P, a first notching device 120N, a second notching device 120P, various inspection and/or measurement devices 130, a first cutter 140N, a second cutter 140P, a winder 150, an identification information management server 160, a roll map programmable logic controller (PLC) 171, a process controller 172, and a server 180.

A first electrode roll ERN may be loaded on the unwinder UWN. The unwinder UWN may be configured to unwind, for example, a first electrode sheet ESN, which may be a negative electrode sheet, from the first electrode roll ERN.

A second electrode roll ERP may be loaded on the unwinder UWP. The unwinder UWP may be configured to unwind, for example, a second electrode sheet ESP, which may be a positive electrode sheet, from the second electrode roll ERP.

A separator roll SR1 may be loaded on the unwinder UWS1, and a separator roll SR2 may be loaded on the unwinder UWS2. The unwinders UWS1 and UWS2 may be configured to unwind separator sheets SS1 and SS2, respectively.

The first electrode sheet ESN, the second electrode sheet ESP, and the two separator sheets SS1 and SS2 may be guided to a guide roll G (not illustrated in FIG. 2 for clarity of illustration and explanation) and moved toward the cutters 140N and 140P and the winder 150.

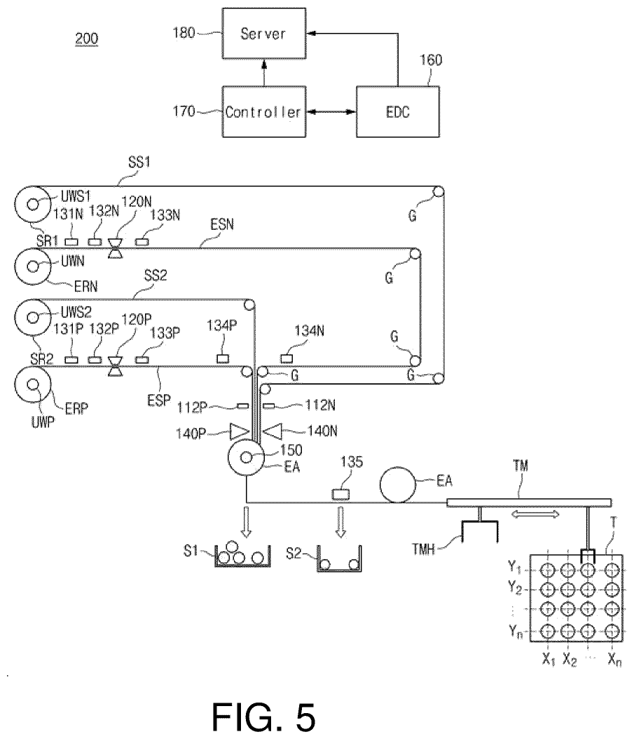

In FIG. 2, for convenience of illustration, the guide roll G is not illustrated, and a movement path of each sheet is also briefly illustrated. However, a more detailed movement path of each sheet is shown in an embodiment of FIG. 5.

A plurality of guide rolls G may be provided to correspond to the movement path of each sheet. The sheets guided by the respective guide rolls G may join at a point in front of the cutters 140N and 140P.

A first position measurement device 111N may be configured to detect the amount of the first electrode sheet ESN unwound from the first electrode roll ERN by the unwinder UWN. Accordingly, the first position measurement device 111N may be configured to generate an input amount signal UWASN indicating a length of the first electrode sheet ESN unwound by the unwinder UWN. The first position measurement device 111N may be configured to transmit the input amount signal UWASN to the roll map PLC 171.

A second position measurement device 112N may be installed near the guide roll where each sheet joins. The second position measurement device 112N may be configured to detect the amount of the first electrode sheet ESN moved to the winder 150. Accordingly, the second position measurement device 112N may be configured to generate a consumption amount signal WASN indicating the length of the first electrode sheet ESN that may be cut by the cutter 140N and wound in the winder 150. The second position measurement device 112N may be configured to transmit the consumption amount signal WASN to the roll map PLC 171.

A first position measurement device 111P may be configured to detect the amount of the second electrode sheet ESP unwound from the second electrode roll ERP by the unwinder UWP. Accordingly, the first position measurement device 111P may be configured to generate an input amount signal UWASP indicating a length of the second electrode sheet ESP unwound by the unwinder UWP. The first position measurement device 111P may be configured to transmit the input amount signal UWASP to the roll map PLC 171.

A second position measurement device 112P may be installed near the guide roll where each sheet joins. The second position measurement device 112P may be configured to detect the amount of the second electrode sheet ESP moved to the winder 150. Accordingly, the second position measurement device 112P may be configured to generate a consumption amount signal WASP indicating the length of the second electrode sheet ESP that is cut by the cutter 140P and wound in the winder 150. The second position measurement device 112P may be configured to transmit the consumption amount signal WASP to the roll map PLC 171.

For example, the first and second position measurement devices (e.g., 111N, 111P, 112N, and 112P) may be rotary encoders capable of representing a position signal of the electrode moving according to the rotation amount of the unwinder, guide roll, or winder as an encoder value. Alternatively, the first and second position measurement devices may be linear encoders for representing a position signal of the electrode corresponding to a moving displacement of the electrode as an encoder value. The encoders may be configured as a contact or non-contact type with respect to the electrode.

According to an exemplary embodiment, the battery manufacturing device 100 of the present embodiment may include an additional position measurement device(s) capable of detecting the position signal of each separator sheet SS1 or SS2.

Each of the first electrode roll ERN and the second electrode roll ERP may be one of electrode rolls transferred to the battery manufacturing system or device 100 after being processed in each leading sub-process (e.g., the coating process, the roll pressing process, or the slitting process). The electrode rolls may include defect tags (NG tags) attached in a leading sub-process (e.g., the roll pressing process or the slitting process). Instead of the defect tags, marking of defect portions may be performed directly on the electrode. Accordingly, the electrode rolls may include a defect indicator or marking portion marked on the electrode in a leading sub-process. In addition, the electrode rolls may include reference points marked at predetermined intervals on the electrode in a leading sub-process (e.g., the coating process). Additionally or alternatively, the markings or indicators may be virtual indicators or marking. That is, the roll map of the present disclosure may include data associated with the markings or indicators that may correspond with one or more features of the electrode(s) or electrode sheet(s). For example, the markings or indicators may correspond with coordinate positions of the electrode sheet(s), including but not limited to, defects or other features of the electrode such as size, pattern, reference points, etc. In addition, the electrode rolls may include a connection portion connecting electrode portions cut by breakage or defect removal during a leading sub-process, between sub-processes, or after a sub-process. For example, a connecting tape (adhesive tape) is attached to the connection portion. By detecting the position of the reference point, the connection portion, or defect marking portion (including the defect tags) of each electrode unwound from each electrode roll by the unwinder in the winding process, a change in length of each electrode sheet in the leading sub-process may be identified. The change in length may be expressed on the roll map as a change in coordinate values. The server 180 stores roll map information for each leading sub-process. Therefore, process control in the winding process may be efficiently performed using the roll map information for each sub-process. In addition, as described below, an event occurring in the moving electrode sheet during the winding process may be detected, and when the position of the reference point, the connection portion, or the defect marking portion changes due to the event, the change may be marked on the roll map in the winding process, which includes process event information in the winding process. Furthermore, by comparing the roll map in the winding process with the roll map in each leading sub-process, changes in electrodes that have occurred between various processes may be identified.

The first electrode sheet ESN unwound from the first electrode roll ERS may be notched by the first notching device 120N before being wound. In addition, the second electrode sheet ESP unwound from the second electrode roll ERS may be notched by the second notching device 120P before being wound.

The notching process is one of the assembly processes and may be defined as a process or stage of processing electrode sheets (a positive electrode sheet and a negative electrode sheet) to manufacture electrode tabs (a positive electrode tab and a negative electrode tab). In the notching process, parts of an uncoated portion of the electrode sheet that is not coated with the electrode material may be cut, and the remaining parts of an uncoated portion that remains after being cut may become an electrode tab.

When a jelly roll-shaped electrode assembly may be manufactured by winding a plurality of electrodes and separators, the notching process and the winding process may be performed on a continuous electrode transfer path.

Referring to FIG. 3, it is shown that the first electrode sheet ESN is notched and a notched portion ESN_n is formed on an uncoated portion of the first electrode sheet. In addition, it is shown that the second electrode sheet ESP is notched and a notched portion ESP_n is formed on an uncoated portion of the second electrode sheet.

After notching, the first electrode sheet may be cut by a first winding length L1 and wound in the winder. The notched portion ESN_n of the first electrode sheet may be provided within the first winding length L1. That is, the first electrode sheet ESN of the first winding length L1 may be longer than the notched portion ESN_n and may include electrode sheet portions extending to both sides of the notched portion.

In addition, the notched portion ESP_n of the second electrode sheet ESP may also be provided within a second winding length L2. That is, the second electrode sheet of the second winding length L2 may be longer than the notched portion ESP_n and has electrode sheet portions extending to both sides of the notched portion.

The separator sheets SS1 and SS2 interposed between the first electrode sheet ESN and the second electrode sheet ESP may be wound by a third winding length L3. For electrical safety or insulation when wound into a jelly roll, the first to third winding lengths may be determined differently. For example, the winding length (third winding length L3) of the separator positioned between the first electrode sheet and the second electrode sheet may be made longer than the winding lengths of the other electrode sheets. Thereby, when the separator of the third winding length L3 is wound and becomes cylindrical, the separator may be positioned on the radial outermost side of the jelly roll electrode assembly, and thus prevent an electrical short circuit from occurring due to direct contact between the first and second electrode sheets. In addition, for example, the winding length (first winding length L1) of the first electrode sheet, which is a negative electrode, may be made longer than the winding length (second winding length L2) of the second electrode sheet, which may be a positive electrode.

Referring back to FIG. 2, the first and second notching devices 120N and 120P may perform notching for each electrode sheet corresponding to each winding length. Notching specifications such as the length of the notched portion formed within the winding length, the size of the electrode tab, and the gap between the electrode tabs may be determined in advance depending on the type or standard of a battery. In addition, the first to third winding lengths may also be determined in advance depending on the type or standard of the battery. Information on notching specifications and winding length may be stored in the process controller 172 or a product production-related server (e.g., the MES) connected to the process controller 172. Accordingly, the process controller 172 may perform notching on each electrode sheet according to set specifications by controlling the first notching device 120N and the second notching device 120P based on the above information.

Each notched electrode sheet may be inspected and/or measured by various inspection and/or measurement devices, and then cut by its winding length by the cutter.

Each of the first electrode sheet ESN, the second electrode sheet ESP, and the separator sheets SS1 and SS2 may be guided by the corresponding guide roll and join at a point in front of the first cutter 140N and the second cutter 140P.

The process controller 172 may control the first cutter 140N to cut the first electrode sheet ESN by the first winding length L1. In addition, the process controller 172 may control the second cutter 140P to cut the second electrode sheet ESP by the second winding length L2. The process controller 172 may control each cutter based on information regarding the first winding length L1, the second winding length L2, and the third winding length L3. The process controller 172 may include data or information of an entire electrode transfer path (distance) taken by the first electrode sheet ESN released from the first electrode roll ERN to the first cutter 140N, an entire electrode transfer path (distance) taken by the second electrode sheet ESP released from the second electrode roll ERP to the second cutter, and separator transfer paths (distances) taken by the separators released from the respective separator rolls to the cutters. For example, the process controller 172 may receive the signals UWASN and UWASP regarding the amounts (input amounts) of each of electrode sheets released from the above-described position measurement devices or signals WASN and WASP regarding the amounts (consumption amounts) reaching the cutters 140N and 140P. Based on these signals, the process controller 172 may identify the total transfer distance of each electrode. In addition, based on information about each winding length, information about notching specifications, and the like, the process controller 172 may identify how many electrode sheet portions corresponding to the winding length there are within the entire transfer distance of each electrode. Accordingly, the process controller 172 may perform notching by a predetermined length on each electrode sheet corresponding to the winding length by controlling each notching device. In addition, the process controller 172 may control each cutter to cut each electrode sheet by a corresponding winding length.

Each cut portion of the first electrode sheet ESN of the first winding length L1 may move to the winder 150 together with the separator sheet SS1. In addition, each cut portion of the second electrode sheet ESP of the second winding length L2 moves to the winder 150 together with the separator sheet SS2. To support the moved electrode sheet, each separator sheet may be moved to the winder 150 without being cut in advance.

The winder 150 may be configured to wind the first electrode sheet ESN, the separator sheet SS1, the second electrode sheet ESP, and the separator sheet SS2 together. Accordingly, an electrode assembly EA of a battery (e.g., a cylindrical cell, pouch-type, prismatic, or any other suitable type of cell configured to accommodate a wound electrode assembly) may be provided. The electrode assembly EA may include a winding structure of the first electrode sheet ESN, the separator sheet SS1, the second electrode sheet ESP, and the separator sheet SS2. The first electrode sheet ESN and the second electrode sheet ESP may be electrically isolated by the separator sheets SS1 and SS2. Accordingly, despite the winding of each sheet, a short circuit of the first electrode sheet ESN and the second electrode sheet ESP may be prevented. The separator sheet may be cut by a separator cutter (not illustrated for clarity of illustration and explanation) after winding.

In the above-described embodiment, it has been described that the first electrode sheet ESN and the second electrode sheet ESP may cut first and wound with the separator sheet.

However, after each electrode sheet and the separator are wound, a connection portion may be cut between an end of the wound electrode assembly and each electrode sheet, and a connection portion may be cut between the end of the wound electrode assembly and the separator. In one embodiment, after the separator sheet SS2, the second electrode sheet ESP, the separator sheet SS1, and the first electrode sheet ESN each reach the target winding length, for separation of the electrode assembly EA, a corresponding cutter may cut the separator sheet SS2, the second electrode sheet ESP, the separator sheet SS1, and the first electrode sheet ESN.

The manufactured electrode assembly EA may be discharged to the outside of the manufacturing or assembly line. The discharged electrode assembly EA may be inspected by a separate inspection device 135 and then transferred to a tray T by a predetermined transfer device TM. The electrode assembly EA determined to be defective by the inspection device 135 may be discharged to an assembly defect storage port S2 and stored therein.

The electrode assembly EA determined to be normal or sufficient (e.g., satisfying a predetermined value or threshold) may be grasped by, for example, a gripper TMH of the transfer device TM and transferred to the tray T. In one embodiment, “normal or sufficient” may be defined as data that satisfies or is within one or more predetermined manufacturing tolerance characteristics or ranges of the electrode manufacturing process according to the present disclosure. Conversely, excessive or insufficient data may be defined as data that does not satisfy or is outside of one or more predetermined manufacturing tolerance characteristics or ranges of the electrode manufacturing tolerances.

in one embodiment, the tray T may include storage positions of a plurality of electrode assemblies EA. Each electrode assembly EA may be stored at a specific position within the tray T, for example, sequentially according to a transfer order or according to a separate loading algorithm. For example, when there may be a plurality of rows X1, X2, . . . , Xn and columns Y1, Y2, . . . , Y3 in the tray T, tray loading positions of the electrode assemblies EA may be specified by ordered pairs of a matrix that is indicated by intersections of the rows and columns.

In one embodiment, when the electrode sheet ESN or ESP containing defects is wound with the separator sheet, the electrode assembly may become a defective electrode assembly and may be discarded to the assembly defect storage port S2. In this case, even the normal electrode sheet and separator sheet that are wound with the defective electrode sheet may be wasted.

Therefore, when the defective electrode sheet approaches the winder 150, the process controller 172 may generate a signal for controlling the unwinder to stop unwinding of other non-defective electrode sheets. Accordingly, only the defective electrode sheet portion may be wound in the winder 150 without winding the normal electrode sheet. The winding body of this defective electrode sheet may be discharged to a defect storage port S1. Accordingly, waste of materials such as the normal electrode, the separator, and the like may be prevented.

Defects in the electrode sheet ESN or ESP may be identified by a defect tag or defect marking attached to the actual electrode in a sub-process (e.g., the roll pressing process or slitting process) before the winding process. Alternatively, when the connecting tape connecting a broken portion is detected during the winding process, a portion of the electrode sheet provided with the connecting tape may be considered defective. Alternatively, a portion determined to be defective by inspection and/or measurement device within the winding process may be considered as a defective electrode.

The electrode rolls ERN and ERP loaded on the unwinder constitute a lot. When each electrode roll is loaded on the unwinder, identification information (e.g., lot number) about each lot may be read by a predetermined reader (e.g., a BCR reader). Alternatively, lot identification information about a corresponding electrode roll may be input into the equipment or system through manual input by the operator. Alternatively, a code or indicator indicating the lot identification information may be included in the reference point, the defect marking, or the like, which may be marked on a suitable surface of the electrode or electrode roll.

Accordingly, the lot identification information about the first electrode sheet ESN and the lot identification information about the second electrode sheet ESP input into the winding process may be identified. In addition, based on the lot identification information, past manufacturing history information, such as roll map information, about the first and second electrode sheets may be identified.

In some embodiments, an electrode prepared from the first electrode sheet ESN and an electrode prepared from the second electrode sheet ESP for forming an electrode assembly in accordance with the present disclosure may be assigned identification information. For example, a cut-count value and/or a coordinate position value associated with the first electrode sheet ESN in accordance with embodiments of the present disclosure may be assigned to the electrode from the first electrode sheet ESN. In one embodiment, the assigned ID may be a virtual ID or a physical ID. A physical ID may be provided as a marking on the electrode if sufficient space (e.g., a uncoated portion) is provided on the electrode. Similarly, a cut-count value and/or a coordinate position value associated with the second electrode sheet ESP in accordance with embodiments of the present disclosure may be assigned to the electrode from the second electrode sheet ESP. In one embodiment, the assigned ID may be a virtual ID or a physical ID. A physical ID may be provided as a marking on the electrode if sufficient space (e.g., a uncoated portion) is provided on the electrode.

In some embodiments, a separator provided for forming an electrode assembly in accordance with the present disclosure may be assigned identification information. For example, a coordinate value and/or a cut-count value associated with the separator in accordance with embodiments of the present disclosure may be assigned to the separator. In one embodiment, the assigned ID may be a virtual ID or a physical ID. A physical ID may be provided as a marking on the separator if sufficient space is provided on the separator.

For example, as described above, the completed electrode assembly EA may be loaded on the tray, and identification information (e.g., tray ID) about the loaded tray T may be related to the corresponding loaded electrode assembly EA. In addition, a loading position of the corresponding electrode assembly on the tray may be identified.

However, as described above, when a plurality of electrode assemblies EA are mixed up in the process of being accommodated in the tray in terms of logistics flow, identifying what material (electrode, separator, or the like) the electrode assembly EA accommodated in the can is made of may be difficult even when a can ID is assigned during the can or housing manufacturing process. For this reason, even though there is manufacturing history information such as roll map information for an electrode in each sub-process before the winding process, it is difficult to relate the manufacturing history information to manufacturing history information about the electrode included in the electrode assembly EA loaded on the tray T or a can or housing.

To overcome the difficulty, the battery device of the exemplary embodiment may include an identification information assigning device for assigning identification information to the electrode assembly EA.

The identification information about the electrode assembly EA may be related to information that may specify the electrode included in the electrode assembly EA. In the winding process, a plurality of electrode sheet portions may be notched, cut, and wound. Therefore, the identification information about the electrode assembly EA may be assigned based on information that may specify the portion of the first electrode sheet of the first winding length L1 and the portion of the second electrode sheet of the second winding length L2.

According to the exemplary embodiment, the identification information about the electrode assembly EA may be assigned based on at least one of i) and ii) below.
i) A cut count value of the first electrode sheet ESN and/or a cut count value of the second electrode sheet ESP, and/or
ii) A position coordinate value of the first electrode sheet ESN corresponding to the first winding length L1 and/or a position coordinate value of the second electrode sheet ESP corresponding to the second winding length L2.

The cut count value (e.g., a cutting order) of the first electrode sheet and the cut count value of the second electrode sheet, which are cut by the first cutter 140N and the second cutter 140P, respectively, may specify the first electrode sheet portion and the second electrode sheet portion included in the electrode assembly EA.

The cut count value of the first electrode sheet cut by the first cutter 140N and the cut count value of the second electrode sheet cut by the second cutter 140P are transmitted to the process controller 172. Since the first winding length L1 and the second winding length L2 may be different, the cut count value of each electrode sheet may be different. In addition, there may be cases where only defective electrode sheets are selectively discharged and normal electrode sheets are not discharged. Accordingly, the cut count value of the first electrode sheet ESN and the cut count value of the second electrode sheet ESP may not match.

The first cutter 140N and the second cutter 140P may include, for example, a cut counter (not shown) equipped with a trigger board (not shown) to calculate the cut count value. The trigger board may generate cut count information based on each winding length (the first winding length or second winding length). The trigger board may increase the count value for each winding length of the received electrode sheet. The trigger board may increase a binary coded decimal (BCD) code by one each time the count value increases. The trigger board may convert the generated cut count value of each electrode sheet into a BCD code and transmit the BCD code to the process controller.

Based on the received cut count value of the first electrode sheet ESN and the received cut count value of the second electrode sheet ESP, the process controller 172 may assign identification information (ID) about the electrode assembly EA wound with the first and second electrode sheets having the corresponding cut count values. In this case, the ID of the electrode assembly EA may be assigned by physically marking the electrode assembly. However, the ID of the electrode assembly EA may be a virtual ID that the process controller 172 virtually assigns identification information to the corresponding electrode assembly EA based on the above-described algorithm.

Since the process controller 172 is capable of data communication with the first and second cutters, the process controller 172 may assign an ID to the electrode assembly EA based on the cut count values of the first and second electrode sheets described above. That is, the process controller 172 may be an identification information assigning device.

However, the process controller 172 is for controlling the unwinder, the notching device, the cutters, and the winder. Therefore, when an operation for assigning an ID to the electrode assembly EA or an ID issuing function is assigned to the process controller 172, an overload may be applied to the process controller 172. In this case, there is a risk that the control speed of the process controller 172 may become slow. To prevent the aforementioned limitations, a dedicated server for assigning and managing identification information may be added. Referring to FIG. 2, the identification information management server 160 data-communicably connected to the process controller 172 is provided. The identification information management server 160 may be, for example, an edge computer system (ECS) and/or an equipment data collection (EDC) server.

For example, the EDC server may receive the cut count values of the first and second electrode sheets from the process controller 172 and issue a virtual ID to the corresponding electrode assembly EA. In this case, the device for assigning identification information to the electrode assembly may be the identification information management server 160.

Alternatively, an entire combination of the process controller 172 and the identification information management server 160 (see the dotted box in FIG. 2) may also be viewed as the identification information assigning device. In one embodiment, an ID of the electrode assembly EA may be assigned by physically marking on the electrode assembly. However, the ID of the electrode assembly EA may be a virtual ID in which the process controller 170 virtually assigns identification information to the corresponding electrode assembly EA.

The process controller 172 and/or the identification information management server 160 may assign identification information to the electrode assembly based on the position coordinate value of the first electrode sheet ESN corresponding to the first winding length L1 and the position coordinate value of the second electrode sheet ESP corresponding to the second winding length L2.

As described above, the battery manufacturing device 100 of the present disclosure includes a position measurement device for generating a position signal of the first electrode sheet moving from the first electrode roll to the winder and a position signal of the second electrode sheet moving from the second electrode roll to the winder. Coordinate data including the position coordinate values may be acquired based on the position signals.

Specifically, based on the encoder values which are the input amount signals UWASN and UWASP of the first position measurement devices 111N and 111P, the position coordinate values of the first electrode sheet portion corresponding to the first winding length L1 and the second electrode sheet portion corresponding to the second winding length L2 may be acquired, respectively.

Alternatively, based on the encoder values which are the consumption amount signals WASN and WASP of the second position measurement devices 112N and 112P, the position coordinate values of the first electrode sheet portion corresponding to the first winding length L1 and the second electrode sheet portion corresponding to the second winding length L2 may be acquired, respectively.

The position coordinate value of the first electrode sheet ESN may include at least one of a start coordinate value and an end coordinate value of the first winding length L1. In addition, the position coordinate value of the second electrode sheet ESP may include at least one of a start coordinate value and an end coordinate value of the second winding length L2.

Accordingly, for example, in relation to, or based on, the start coordinate value and the end coordinate value of the first winding length L1 of the first electrode sheet and the start coordinate value and the end coordinate value of the second winding length L2 of the second electrode sheet, the process controller 172 and/or the identification information management server 160 may assign identification information (ID) to a corresponding electrode assembly EA.

Since the process controller 172 may be connected to the above-mentioned first and second position measurement devices to control each position measurement device and allow data to communicate therebetween, the process controller 172 may acquire coordinate values corresponding to the winding lengths of the first and second electrode sheets to be cut.

The encoder values (position signals) of the encoders may be directly applied to the position coordinate values of the above-mentioned first and second electrode sheets. Alternatively, the position signals may be converted into coordinate values of a new unit through a predetermined scale conversion. The roll map PLC 171, which will be described below, may be configured to collect coordinate data of each electrode sheet based on the position signals.

As a preferred embodiment, the ID may be assigned to the corresponding electrode assembly EA based on both the position coordinate values and cut count values of the first electrode sheet ESN and the second electrode sheet ESP wound into the electrode assembly EA.

Once the ID of the electrode assembly EA is identified, the cut count values and coordinate values of the electrodes included in the electrode assembly are specified. Based on the cut count values and coordinate values, the manufacturing history of each sub-process before the winding process may be traced. In addition, defect inspection, transfer, tray loading, and can storage processes of the electrode assembly are performed based on the ID of the electrode assembly EA. Accordingly, the manufacturing history may be easily traced even in a process following the winder 150 based on the identification information about the electrode assembly EA.

In one embodiment, the process controller 172 and/or the identification information management server 160 may manage the identification information about the electrode assembly EA in relation to the process event data of each electrode.

According to one exemplary embodiment, the battery manufacturing device 100 may further include the roll map PLC 171.

The roll map PLC 171 may be configured to collect coordinate data CD of the electrode sheets ESP and ESN based on the input amount signals UWASN and UWASP and the consumption amount signals WASN and WASP of the electrode sheets ESN and ESP.

As one example, the roll map PLC 171 may determine moving distances of the electrode sheets ESN and ESP based on the input amount signals UWASN and UWASP of the electrode sheets ESN and ESP. Accordingly, the roll map PLC 171 may be configured to determine positions of the portions of the electrode sheets ESN and ESP that are unwound by the unwinders UWN and UWP within the electrode sheets ESN and ESP at each point in time when an event occurs in the electrode sheets ESN and ESP. The event may include inspection of the electrode sheet by the inspection and/or measurement device, detection of a reference point marked on the electrode sheet, detection of an NG tag, completion of the electrode assembly EA, and disposal of an electrode or electrode assembly EA containing a defect.

As another example, the roll map PLC 171 may determine the moving distances of the electrode sheets ESN and ESP based on the consumption amount signals WASN and WASP of the electrode sheets ESN and ESP. Accordingly, the roll map PLC 171 may be configured to determine positions of the portions of the electrode sheets ESN and ESP that are wound by the winders 150 within the electrode sheets ESN and ESP at each point in time when an event occurs in the electrode sheets ESN and ESP. As another example, the roll map PLC 171 may determine the moving distances of the electrode sheets based on each of the consumed amount signals and the input amount signals.

Coordinate data may include a coordinate value matching each portion of the electrode sheets ESP and ESN. That is, each of arbitrary points on the electrode sheets ESP and ESN may match the coordinate value. The coordinate value may be a one-dimensional quantity of the moving direction of the electrode sheets ESP and ESN, but is not limited thereto. The coordinate value may be a two-dimensional quantity in the moving direction and a Y direction, which is a transverse direction of the electrode sheets ESP and ESN.

In order to inspect the first electrode sheet and the second electrode sheet, at least one first electrode inspection and/or measurement device is provided between the first electrode roll and the winder, and at least one second electrode inspection and/or measurement device may be provided between the second electrode roll and the winder.

For convenience of description, only one inspection and/or measurement device 130 is shown in FIG. 2, but the inspection and/or measurement device may be provided for each electrode sheet. According to exemplary embodiments, the inspection and/or measurement device 130 may be a vision inspection device. Each inspection and/or measurement device 130 may include a sensing unit 130A and a processing unit 130B. The sensing unit 130A and the processing unit 130B may be connected by wire or wirelessly.

The sensing unit 130A may include an imaging device such as a time delay and integration (TDI) camera, a complementary metal oxide semiconductor (CMOS) image sensor, or the like. The sensing unit 130A may be configured to generate an inspection signal IS indicating a surface of the first electrode sheet ESN or a measurement signal MS measuring the size, width, or the like. The sensing unit 130A may be configured to transmit the inspection signal IS or the measurement signal MS to the processing unit 130B. The inspection signal IS may include, for example, an image of surfaces of the electrode sheets ESP and ESN.

The processing unit 130B may be configured to determine a determination value indicating presence or absence of a defect in the electrode sheets ESP and ESN based on the inspection signal IS and/or the measurement signal MS. The processing unit 130B may be configured to generate the determination value of the electrode sheets ESP and ESN by processing the inspection signal IS and/or the measurement signal MS based on a set algorithm.

The processing unit 130B may be configured to collect the inspection and/or measurement data IMD related to the coordinate values based on the inspection signal IS and/or measurement signal MS and the coordinate data CD. The processing unit 130B may be configured to collect the inspection and/or measurement data IMD related to the coordinate value by matching the determination value determined based on the inspection signal IS and/or the measurement signal MS to the coordinate value of the coordinate data CD. The processing unit 130B may be configured to transmit the inspection and/or measurement data IMD to the roll map PLC 171.

To match the determination value to the coordinate value of the coordinate data CD, the processing unit 130B may be configured to correct the coordinate value of the coordinate data CD.

According to exemplary embodiments, a single coordinate value indicating the position of a defect may be matched to the determination value of the inspection and/or measurement data IMD, or a start coordinate value indicating the start of the defect and an end coordinate indicating the end thereof may also be matched to the determination value.

The roll map PLC 171 may be configured to transmit the inspection and/or measurement data IMD to the process controller 143.

The process controller 172 may be configured to transmit the inspection and/or measurement data IMD to the server 180 via an intermediate server, such as an EIF. The server 180 may be configured to generate each of roll maps of the first electrode roll and the second electrode roll provided to the winding process based on the inspection and/or measurement data IMD and additional process event data.

Meanwhile, when the roll map PLC 171 is also equipped with an additional server of appropriate capacity, the roll map PLC 171 itself may be configured to generate each of roll maps of the first electrode roll and the second electrode roll.

In this sense, the roll map PLC 171 or the server 180, or the assembly of the roll map PLC and the server 180 (see the dotted box in FIG. 2) may be the roll map creation server of the present disclosure.

The roll map creation server may create a first electrode roll map that is a simulated electrode in which a first coordinate value indicating the position of the first electrode sheet moving from the first electrode roll to the winder and process event data acquired according to the movement of the first electrode sheet are represented in relation, and a second electrode roll map that is a simulated electrode in which a second coordinate value indicating the position of the second electrode sheet moving from the second electrode roll to the winder and process event data acquired according to the movement of the second electrode sheet are represented in relation.

As described above, the roll map PLC 171 or the server 180 connected thereto may acquire the coordinate value of each electrode sheet where an event occurs and inspection and/or measurement data related to each process matched thereto.

In addition, equipment data acquired from each process equipment from the first and second electrode rolls to the winder and time series data acquired from each process may be acquired through the process controller 172. The process controller may transmit the equipment data and time series data to the server 180.

The process event data may be matched to the coordinate values (the first coordinate value and the second coordinate value) of each electrode sheet, and the coordinate values and the process event data may be displayed in relation in the roll map of the first electrode and the roll map of the second electrode.

In this way, even in the winding process from the electrode rolls to the winder, roll maps may be created for the first electrode sheet and the second electrode sheet, respectively. By comparing first electrode roll map information (coordinate values and process event data) and second electrode roll map information (coordinate values and process event data) of the winding process with roll map information (coordinate values and process event data) of each sub-process before the winding process, a manufacturing history, changes in electrode length, and quality changes between the electrode process and the winding process may be identified.

The identification information assigning device may be connected to the roll map creation server. That is, the identification information assigning device such as the process controller 172 and/or the identification information management server 160 may be connected to the roll map PLC 171 indirectly, for example, via the process controller 172. Alternatively, the identification information assigning device may be directly connected to the server 180. Accordingly, the identification information assigning device may manage the identification information about the electrode assembly EA in relation to process event data that occurs when the first and second electrode sheets are moved. In particular, the identification information assigning device may relate the identification information about the electrode assembly EA to at least one of first and second coordinate values and process event data included in the first and second electrode roll maps, based on information from the roll map creation server. The first and second coordinate values, which are the roll map coordinate values, may include a start coordinate value and an end coordinate value of the first winding length L1, and a start coordinate value and an end coordinate value of the second winding length L2.

Accordingly, the identification information assigning device, particularly the identification information management server 160, may manage the identification information about the electrode assembly EA in relation to one or more of the following.
1) Lot identification information about the first electrode sheet and/or lot identification information about the second electrode sheet,
2) A cut count value of the first electrode sheet and/or a cut count value of the second electrode sheet,
3) A position coordinate value of the first electrode sheet corresponding to the first winding length and/or a position coordinate value of the second electrode sheet corresponding to the second winding length,
4) Data on defects of the first electrode sheet and/or the second electrode sheet,
5) Data on defects of the electrode assembly,
6) Tray identification information about a tray on which the electrode assembly is loaded,
7) Data on a loading position of the electrode assembly in the tray, and
8) Can identification information about an electrode can in which the electrode assembly is accommodated.

The lot identification information in 1) may be acquired, for example, when each electrode roll is loaded on a corresponding unwinder, and thus may be related to the identification information about the electrode assembly EA.

As described above, since the identification information about the electrode assembly EA is assigned based on the cut count values of the first and second electrode sheets and/or the position coordinate values corresponding to the respective winding lengths of the first and second electrode sheets, the identification information about the electrode assembly may be naturally related to the count values in 2) and the position coordinate values in 3).

In addition, defects may be determined using inspection and/or measurement data IMD acquired by the inspection and/or measurement device 130, and the determination values may also be acquired by the identification information management server 160 through the roll map PLC 171. Depending on the type of inspection and/or measurement device 130, the type of defect may be identified. Therefore, data regarding defects of the first electrode sheet and the second electrode sheet may be related to the identification information about the electrode assembly EA.

The electrode assembly EA may be inspected by a predetermined inspection device 135 after completion, and the identification information about the defective electrode assembly EA may be reported to the identification information management server 160. Accordingly, the identification information about the electrode assembly EA may be related to data regarding defects of the electrode assembly.

As illustrated in FIG. 2, the electrode assembly EA to which identification information (ID) is assigned is loaded at a specific loading position on the tray T with a predetermined ID. The tray identification information and the data regarding the loading position may also be related to the identification information about the electrode assembly EA.

The electrode assembly EA loaded on the tray T may be accommodated in a cylindrical can or a square can, and each can may have can identification information such as a can ID. Accordingly, the ID of the electrode assembly EA and the ID of the can may be related.

FIG. 4 illustrates an example in which several pieces of data may be related through the identification information (e.g., jelly roll virtual or physical ID) about the electrode assembly EA.

Lot IDs of a positive electrode and a negative electrode may be related to a virtual or physical ID of the electrode assembly EA. In addition, cut count values of the positive electrode and the negative electrode included in the corresponding electrode assembly may be related to the virtual or physical ID. In addition, start and end coordinate values for a negative electrode portion of the first winding length L1 and start and end coordinate values for a positive electrode portion of the second winding length L2 (roll map coordinate values), which correspond to the cut count values, are related.

Furthermore, a defect classification mark for the corresponding electrode portion, a tray ID, and even a loading position on the tray are related.

In this way, according to the present disclosure, unique identification information may be assigned to each electrode assembly EA manufactured in the winder 150, and the identification information may be related to cut count values, coordinate values, and roll map information (roll map coordinates, process event data) in the winding process. In addition, the process event data matched to the cut count value and the coordinate value may be additionally related to the identification information about the electrode assembly.

Therefore, according to the present disclosure, it can be seen that it is possible to easily trace quality within the winding process as well as between the winding process and processes before and after the winding process.

Referring to FIGS. 1 and 2, the components of the process controller 172, the processing unit 130B, the roll map PLC 171, the identification information management server 160, and the server 180 may be implemented as hardware, firmware, software, and a combination thereof. For example, the components may include a computing device such as a workstation computer, a desktop computer, a laptop computer, a tablet computer, or the like. The components may include any one of a simple controller, a microprocessor, a complex processor such as a CPU, GPU, or the like, a processor configured by software, dedicated hardware, and firmware. The components may be implemented, for example, by a general-purpose computer or application-specific hardware such as a digital signal processor (DSP), a field programmable gate array (FPGA), an application specific integrated circuit (ASIC), and the like.

The server 180 and any other servers disclosed in accordance with the present disclosure may include a physical server or a cloud server. The server 180 may provide data and analysis results to the operator through various frameworks. The framework may include protocols supporting data transmission so that the display device 190 (see FIG. 1) is able to visualize data through a user interface and provide updated visualizations as new data is computed by the server 180. Protocols supporting the data transmission may use HTML, JavaScript, and/or JSON.

The server 180 may transmit a visualization command (VC) to the display device 190, and the display device may visualize the roll map and display the visualized roll map.

The server 180 may include various application programming interfaces (APIs) for storing data in databases and other data management tools. The API may also be used for retrieval of data in databases of various data management systems. The data management system can provide access to a database, pull data from the database, retrieve data, and generate metrics. Here, metrics are tools for visualizing data. The metrics may contain measurement values generated in time series and may be used for monitoring applications and creating state alerts.

According to some embodiments, the operations of the components may be implemented as instructions stored on a computer or machine-readable medium, capable of being read and executed by one or more processors. Here, the machine-readable medium may include any mechanism for storing and/or transmitting information in a form readable by a machine (e.g., a computing device). For example, the machine-readable medium may include a read-only memory (ROM), a random-access memory (RAM), a magnetic disk storage medium, an optical storage medium, a flash memory, electrical, optical, acoustic, or other forms of radio signals (e.g., carrier waves, infrared signals, digital signals, or the like) and other arbitrary signals.

The components may include firmware, software, routines, and instructions to perform the above-described operations. For example, the process controller 172, the processing unit 130B, the roll map PLC 171, the identification information management server 160, and the server 180 may be instantiated in a memory.

FIG. 5 shows a battery manufacturing device according to an exemplary embodiment.

The battery manufacturing device 100 of the present embodiment may include unwinders UWN, UWP, UWS1, and UWS2, position measurement devices 111N, 111P, 112N, and 112P, a first notching device 120N, a second notching device 120P, various inspection and/or measurement devices, a first cutter 140N, a second cutter 140P, a winder 150, and an identification information management server 160.

In addition, the processes of inspecting an electrode assembly wound in the winder 150, discharging a defective electrode assembly, and loading the electrode assembly onto a tray are similar to one or more foregoing embodiments of the present disclosure.

In one embodiment, the description of the same parts as the one or more foregoing embodiments of the present disclosure will be omitted, and the description will focus on the different parts.

FIG. 5 illustrates a first electrode sheet ESP, a second electrode sheet ESN, and separator sheets SS1 and SS2 moving toward the cutters and winder by their respective guide rolls G.

In one embodiment, the sheets may be arranged in the order of the separator sheet SS1, the first electrode sheet ESN, the separator sheet SS2, and the second electrode sheet ESP from above. The separator sheet SS2 may be interposed between the first electrode sheet ESN and the second electrode sheet ESP, and the arrangement of the sheets may be different from one or more of the foregoing embodiments in which the separator sheet SS1 may be interposed between the first electrode sheet ESN and the second electrode sheet ESP.

In one embodiment, the roll map PLC 171 and the process controller 172 of the first embodiment may be configured as one integrated controller 170.

The integrated controller 170 may be configured to perform the functions of the roll map PLC 171 and the process controller 172 in FIG. 2. Accordingly, the integrated PLC 170 may be configured to generate coordinate data CD based on one of the input amount signals UWASN and UWASP and the consumption amount signals WASN and WASP, and acquire the coordinate data CD and inspection and/or measurement data IMD and transmit the acquired data to the server 180. The integrated controller 170 may be configured to generate signals to control the unwinders UWN, UWP, UWS1, and UWS2, the notching devices 120N and 120P, the cutters 140N and 140P, and the winder 150.

In addition, the integrated controller 170 may be connected to the identification information management server 160 and provide the identification information management server 160 with information (coordinate values and cut count values) that is the basis for assigning identification information about the electrode assembly. In addition, the integrated controller 170 may relate the identification information about the electrode assembly to the coordinate values or process event data. Alternatively, the integrated controller 170 may provide the coordinate values and/or process event data to the identification information management server 160 so that the identification information management server 160 may perform the related task.

Further, in one embodiment, the inspection and/or measurement devices may be provided between the electrode rolls and the winder 150.

For example, between the electrode rolls and the notching devices, a reference point measurement device 131N and a seam sensor 132N for the first electrode sheet ESN and a reference point measurement device 131P and a seam sensor 132P for the second electrode sheet ESP are installed. There may be a risk that the reference point marked on the uncoated portion of the electrode sheet is removed during subsequent notching by the notching device. Accordingly, reference point measurement devices may be installed before the notching devices to measure reference points on the electrode sheets in advance. The reference point measurement devices 131N and 131P may measure reference point positions of the respective electrode sheets and compare the reference points with the reference point positions in respective leading sub-processes. In addition, the seam sensors 132N and 132P may detect seams (that is, connecting tapes) of the respective electrode sheets. Positions of the connecting tapes detected by the seam sensors may also be compared with positions of the connecting tapes of the electrode sheets in the respective leading sub-processes. The reference points and connecting tapes of each electrode sheet before and after the winding process are compared, and based on changes in the positions of the reference points and connecting tapes identified as a result of the comparison, changes in the lengths of the electrode sheets, broken positions, and the like may be identified. When the first electrode roll map for the first electrode sheet and the second electrode roll map for the second electrode sheet may be created in the winding process based on the identification, coordinates of the reference points and seam positions on the corresponding electrode roll maps may be corrected.

After the notching devices 120N and 120P, predetermined inspection and/or measurement devices may be installed at preset positions. For example, appearance inspection devices 133N and 133P may be installed for the respective electrode sheets. Alternatively, a dimension/width inspection device may also be installed. Second seam sensors 134N and 134P may be installed at positions just before the electrode sheet and the separator are joined to finally detect the positions of seams provided on the electrode sheets.

The multiple inspection and/or measurement devices may be connected to the roll map PLC 171 as shown in FIG. 2 or the integrated controller 170 in FIG. 3 to transmit inspection and/or measurement data (IMD) acquired from the inspection and/or measurement devices. In addition, each inspection and/or measurement device may include the sensing unit and the processing unit, respectively, as described above.

The process controller 170 or any controllers or processor(s) associated with the battery manufacturing systems 10 and 1000 corresponding to embodiments associated with FIGS. 1-7 may include suitable logic, circuitry, interfaces, or code that is configured to execute the instructions stored in one or more memories or any of the servers (e.g., 160, 180, 181) for carrying out some or all functions or operations of tracking, monitoring, and manufacturing electrodes, electrode assemblies, and batteries, as well as generating roll maps, in accordance with embodiments of the present disclosure. For example, The process controller 170 or any controllers or processor(s) associated with the battery manufacturing systems 10 and 1000 may include but are not limited to a processor(s), a digital signal processor(s) (DSP), a microprocessor(s), a microcontroller(s), a complex instruction set computing (CISC) processor(s), an application-specific integrated (ASIC) processor(s), a reduced instruction set (RISC) processor(s), a very long instruction word (VLIW) processor(s), a state machine, a data processing unit(s), a graphics processing unit(s) (GPU), and other processors or control circuitry. Additionally or alternatively, the process controller 170 or any controllers or processor(s) associated with the battery manufacturing systems 10 and 1000 may be located in one or more of the server system(s) described in the foregoing embodiments for carrying out some or all functions or operations of tracking, monitoring, and manufacturing electrodes, electrode assembly, and batteries, as well as generating roll maps, in accordance with embodiments of the present disclosure.

The roll maps may be stored in a database or any of the server(s) described in the foregoing embodiments or a separate storage medium. The database or the storage medium may be, for example, a memory. A plurality of memories may also be provided, as necessary. The memory may be a volatile memory or a non-volatile memory. As the memory of the volatile memory, a random access memory (RAM), a dynamic RAM (DRAM), a static RAM (SRAM), or the like may be used. As the memory of the non-volatile memory, a read only memory (ROM), a programmable ROM (PROM), an electrical alterable ROM (EAROM), an erasable programmable ROM (EPROM), an electrically erasable programmable ROM (EEPROM), a flash memory, or the like may be used. Examples of the above-listed memories are merely illustrative and are not limited to these examples. Alternatively, the storage medium may be a hard disk, a CD-ROM, a USB memory, a solid state drive (SSD), or the like.

The roll map and related data stored in the storage medium may be freely used in battery manufacturing, quality control, analysis, and problem tracking.

Computer-readable media having stored thereon instructions configured to cause one or more computers to perform any of the methods described herein are also described. In one embodiment, the computer-readable media may be non-transitory. A computer readable medium may include volatile or nonvolatile, removable or nonremovable media implemented in any method or technology capable of storing information, such as computer readable instructions, data structures, program modules, or other data. In general, functionality of computing devices described herein may be implemented in computing logic embodied in hardware or software instructions, which can be written in a programming language, such as C, C++, COBOL, JAVA™, PHP, Perl, Python, Ruby, HTML, CSS, JavaScript, VBScript, ASPX, Microsoft .NET™ languages such as C #, and/or the like. Computing logic may be compiled into executable programs or written in interpreted programming languages. Generally, functionality described herein can be implemented as logic modules or circuitry that can be duplicated to provide greater processing capability, merged with other modules, or divided into sub modules. The computing logic can be stored in any type of computer readable medium (e.g., a non-transitory medium such as a memory or storage medium) or computer storage device and be stored on and executed by one or more general purpose or special purpose processors, thus creating a special purpose computing device configured to provide functionality described herein.

One or more aspects of FIGS. 1-7 may be incorporated into or combined with one or more aspects of the embodiments disclosed in the present disclosure. Further, detailed disclosure of the similar or identical elements already described may be omitted for brevity. However, such omissions are not disclaimers or disavowals, and except to the extent that the similar or identical elements that are already described are inconsistent with the express disclosure herein, in which case the language in the present disclosure hereinafter controls.

The applications and the functionalities disclosed in the foregoing and following embodiments may be achieved by programming the process controller 170 or any controllers or processor(s) associated with the battery manufacturing systems 10 and 1000 in accordance with the present disclosure. That is, the process controller 170 or any controllers or processor(s) associated with the battery manufacturing systems 10 and 1000 in the foregoing and following embodiments may utilize, for example, computer-readable media having stored thereon instructions configured to cause one or more computers or processors to perform any of the methods described herein.

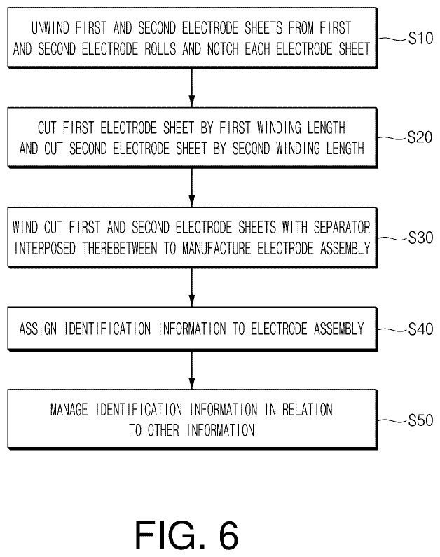

FIG. 6 is a flowchart for describing a battery manufacturing method according to an exemplary embodiment.

Referring to FIGS. 2, 3, and 6, the first electrode sheet ESN and the second electrode sheet ESP are unwound from the first electrode roll ERN and the second electrode roll ERP, respectively, and moved toward the winder 150. In addition, the separator sheet is also unwound from a separator roll corresponding to each electrode roll and moved toward the winder 150. The unwound first electrode sheet ESN is notched at a predetermined portion within the first winding length L1 by the first notching device 120N so that an electrode tab is formed. Further, the unwound second electrode sheet ESP is notched at a predetermined portion within the second winding length L2 by the second notching device 120P so that an electrode tab is formed.

The process controller 172 may move the electrode sheet and the separator sheet by operating the unwinder corresponding to each electrode roll and separator roll, and may also notch each electrode sheet by controlling each notching device 120N or 120P to correspond to the moving speed of the electrode sheet (operation S10).

The first electrode sheet ESN and the second electrode sheet ESP moving to the winder 150 may be inspected and measured by a predetermined inspection and/or measurement device before and/or after the notching. Inspection and/or measurement data IMD related to coordinate values acquired by the inspection and/or measurement device may be transmitted to the server 180 through the roll map PLC 171 and the process controller 172. Alternatively, the inspection and/or measurement data IMD may be transmitted to the server 180 through the integrated controller 170.

The roll map PLC 171 or the server 180 may create a first electrode roll map imitating the first electrode sheet ESN and a second electrode roll map imitating the second electrode sheet ESP based on the coordinate values and inspection and/or measurement data. In the first electrode roll map, a first coordinate value indicating the position of the first electrode sheet may be displayed in relation to process event data. In the second electrode roll map, a second coordinate value indicating the position of the second electrode sheet may be displayed in relation to the process event data. The roll map data may be related to identification information assigned to an electrode assembly EA, which will be described below.

Each electrode sheet that is inspected and/or measured may be moved by a corresponding guide roll to join the separator sheet. In this process, the first electrode sheet ESN may be cut by the first winding length L1 by the first cutter 140N, and the second electrode sheet ESP may be cut by the second winding length L2 by the second cutter 140P (operation S20).

The first electrode sheet portion of the first winding length and the second electrode sheet portion of the second winding length are wound in the winder 150 with a separator interposed therebetween to complete a jelly roll-shaped electrode assembly EA (operation S30). The winder 150 may be equipped with a separate cutter for cutting the separator sheet. In this case, the first electrode sheet of the first winding length and the second electrode sheet of the second winding length may be manufactured into the electrode assembly by being wound together with a separator of the third winding length L3.

For the completed electrode assembly EA, the predetermined identification number assigning device may assign identification information to the electrode assembly EA based on at least one of the following i) and ii) (operation S40).

a cut count value of the first electrode sheet and/or a cut count value of the second electrode sheet, and/or

a position coordinate value of the first electrode sheet corresponding to the first winding length and/or a position coordinate value of the second electrode sheet corresponding to the second winding length.

The cut count values may be acquired by a cut counter provided in the cutters, or the like, and the cut count values may be transmitted to the process controller 172 or the identification information management server 160.

The position coordinate values of the first and second electrode sheets may be acquired by the roll map PLC 171 or the integrated controller 170 based on position signals (encoder values) of the position measurement devices. The acquired position coordinate values may be transmitted to the process controller 172 or the identification information management server 160. The identification information assigning device, which is the process controller 172, the identification information management server 160, or a combination thereof, may assign, for example, virtual identification information (ID) to the completed electrode assembly EA based on the cut count values and/or position coordinate values (operation S40).

The identification information about the electrode assembly EA may be related to one or more of the following by the identification information assigning device (the process controller 172, the identification information management server 160, or the combination thereof) or the roll map creation server (the roll map PLC 171, the server 180, or the combination thereof) (operation S50).
1) Lot identification information about the first electrode sheet and/or lot identification information about the second electrode sheet,
2) A cut count value of the first electrode sheet and/or a cut count value of the second electrode sheet,
3) A position coordinate value of the first electrode sheet corresponding to the first winding length and/or a position coordinate value of the second electrode sheet corresponding to the second winding length,
4) Data on defects of the first electrode sheet and/or the second electrode sheet,
5) Data on defects of the electrode assembly,
6) Tray identification information about a tray on which the electrode assembly is loaded,
7) Data on a loading position of the electrode assembly in the tray, and
8) Can identification information about an electrode can in which the electrode assembly is accommodated.

In this case, the position coordinate value of the first electrode sheet ESN may include at least one of a start coordinate value and an end coordinate value of the first winding length, and the position coordinate value of the second electrode sheet ESP may include at least one of a start coordinate value and an end coordinate value of the second winding length.

In addition, the position coordinate values of the first and second electrode sheets may be roll map coordinate values included in a first electrode roll map that is a simulated electrode imitating the first electrode sheet moving from the first electrode roll to a winder and a second electrode roll map that is a simulated electrode imitating the second electrode sheet moving from the second electrode roll to the winder.

In addition, the identification information about the electrode assembly EA may be further related to process event data acquired when the first electrode sheet moves from the first electrode roll to the winder and when the second electrode sheet moves from the second electrode roll to the winder.

The process event data may include at least one of equipment data acquired from each process equipment from the first and second electrode rolls to the winder, process-related inspection and/or measurement data acquired in each process, and time series data acquired in each process.

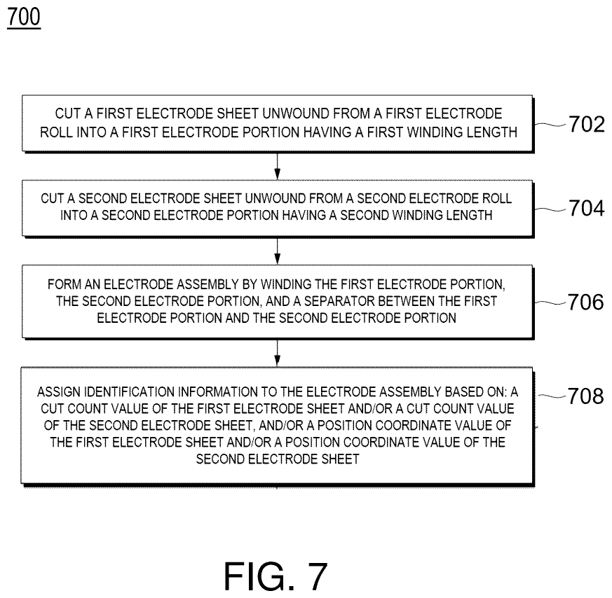

FIG. 7 depicts a flowchart of an exemplary method 700 for a method of manufacturing a battery, according to aspects of the present disclosure. For example, the method 700 may be performed according to one or more embodiments as well as one or more systems described in reference to FIGS. 1-7.

At step 702, a first electrode sheet unwound from a first electrode roll may be cut into a first electrode portion having a first winding length. At step 704, a second electrode sheet unwound from a second electrode roll may be cut into a second electrode portion having a second winding length. At step 706, an electrode assembly may be formed by winding the first electrode portion, the second electrode portion, and a separator between the first electrode portion and the second electrode portion. At step 708, identification information may be assigned to the electrode assembly based on: a cut count value of the first electrode sheet and/or a cut count value of the second electrode sheet, and/or a position coordinate value of the first electrode sheet and/or a position coordinate value of the second electrode sheet.

In other aspects, the method of manufacturing a battery may include one or more of the following features or steps. The method may further include, prior to the cutting of the first electrode sheet and the second electrode sheet, performing a notching process to form one or more electrode tabs on the first electrode sheet and the second electrode sheet. The notching process of the first electrode sheet is performed within the first length. The notching process of the second electrode sheet is performed within the second length. The separator may include a third length. The third length may be greater than the first length and the second length. The identification information of the electrode assembly may include: 1) lot identification information of the first electrode sheet and/or lot identification information of the second electrode sheet; 2) data regarding defects of the first electrode sheet and/or the second electrode sheet; 3) data regarding defects of the electrode assembly; 4) tray identification information of a tray on which the electrode assembly is loaded; 5) position data of a loading position of the electrode assembly in the tray; and 6) can identification information of an electrode can in which the electrode assembly is accommodated. The position coordinate value of the first electrode sheet may include at least one of a start coordinate value of the first length or an end coordinate value of the first length, or the position coordinate value of the second electrode sheet may include at least one of a start coordinate value of the second length or an end coordinate value of the second length. The position coordinate value of the first electrode sheet may be included in a first electrode roll map and the position coordinate value of the second electrode sheet may be included in a second electrode roll map. The first electrode roll map may include a simulated first electrode sheet moving from the first electrode roll to a winder. The second electrode roll map may be a simulated second electrode sheet moving from the second electrode roll to the winder. The identification information of the electrode assembly may be further related to process event data acquired when the first electrode sheet moves from the first electrode roll to a winder and when the second electrode sheet moves from the second electrode roll to the winder. The process event data may include: equipment data acquired from one or more process equipment devices between the first electrode roll to the winder and the second electrode roll to the winder; inspection and/or measurement data acquired in the one or more processes; and time series data acquired in the one or more processes.

The systems, methods, and battery described in connection with FIGS. 1-7 of the present disclosure improve the conventional battery manufacturing, monitoring, and tracking technology. That is, the system 100, 200, battery(s), processes, and methods of the present disclosure described herein are directed to an improvement in the field of conventional battery technology and are practically applicable to the field of battery manufacturing, monitoring, and tracking technology by utilizing the system 100, 200, as well as the methods, processes, and functionality disclosed in connections with FIGS. 1-7 of the present disclosure. Accordingly, for example, the combined steps of the methods described in reference to FIGS. 6 and 7 improve quality tracing of electrodes and electrode assemblies containing the electrodes that may be performed within the winding process as well as between the winding process and processes before and after the winding process through the identification information about the electrode assembly in a nonconventional way. Accordingly, the manufacturing reliability of workpieces, intermediate products, and products may be improved throughout the entire battery manufacturing process.

In general, any process discussed in this disclosure that is understood to be computer-implementable, such as the processes shown in references to FIGS. 1-7 and the systems and/or interfaces described in connection with FIGS. 1-7, may be performed or otherwise implemented by one or more processors of a computer system. A process or process step performed by one or more processors may also be referred to as an operation. The one or more processors may be configured to perform such processes by having access to instructions (e.g., software or computer-readable code) that, when executed by the one or more processors, cause the one or more processors to perform the processes. The instructions may be stored in a memory of the computer system. A processor may be a central processing unit (CPU), a graphics processing unit (GPU), or another type of processing unit.

A computer apparatus or system described in reference to FIGS. 1-7, or any other system performing operation to facilitate tracking and monitoring of manufacturing data of one or more batteries and/or battery components, may include one or more computing devices. If the one or more processors of the computer system are implemented as a plurality of processors, the plurality of processors may be included in a single computing device or distributed among a plurality of computing devices. If a computer system comprises a plurality of computing devices, the memory of the computer system may include the respective memory of each computing device of the plurality of computing devices.

According to the method of the present disclosure, quality tracing of electrodes and electrode assemblies containing the electrodes may be performed within the winding process as well as between the winding process and processes before and after the winding process through the identification information about the electrode assembly. Accordingly, the manufacturing reliability of workpieces, intermediate products, and products may be improved throughout the entire battery manufacturing process.

Above, the present disclosure has been described in more detail through drawings and embodiments. However, configurations shown in the drawings and embodiments are merely one embodiment of the present disclosure, and, not intended to fully describe the technical aspects of the present disclosure, so it should be understood that a variety of other equivalents and modifications could be made thereto at the time of filing the application.

What is claimed is:

1. A data tracking method comprising:
acquiring an identification information of an electrode assembly;
acquiring at least one of a cut count value and a coordinate values of at least one electrode included in the electrode assembly based on the identification information of the electrode assembly; and
retrieving data related to the electrode in each sub-process of an electrode process prior to a winding process in which the electrode assembly is manufactured, based on at least one of the cut count value and the coordinate value.

2. The data tracking method of claim 1,
wherein the data related to the electrode in each sub-process comprises:
at least one of coordinate data corresponding to the at least one of the cut count value and the coordinate value and process event data related to the electrode in each sub-process.

3. The data tracking method of claim 2,
wherein the process event data in each sub-process comprises:
at least one of process-related inspection data and measurement data, or time-series data acquired in each process.

4. The data tracking method of claim 1,
wherein the data related to the electrode of each sub-process comprises:
a roll map data of each process generated in each sub-process.

5. The data tracking method of claim 1, further comprising:
retrieving data associated with the identification information in at least one of the winding process and a subsequent process of the winding process, based on the identification information of the electrode assembly.

6. The data tracking method of claim 5,
wherein the data associated with the identification information in the winding process comprise: electrode roll map data or process event data in the winding process.

7. The data tracking method of claim 5,
wherein the data associated with the identification information in the winding process comprise: at least one of lot identification information of the electrode or an electrode sheet in the winding process and data regarding defects in the electrode sheet in the winding process.

8. The data tracking method of claim 5,
wherein the data associated with the identification information in the subsequent process of the winding process comprises:
at least one of:
data regarding defects in the electrode assembly;
tray identification information of a tray on which the electrode assembly is loaded;
position data of a loading position of the electrode assembly in the tray; and
identification information of a housing or can in which the electrode assembly is accommodated.

9. A data tracking method comprising:
acquiring an identification information of an electrode assembly; and
retrieving data related to the electrode assembly in at least one of: each sub-process of an electrode process prior to the winding process in which the electrode assembly is manufactured; the winding process; and a subsequent process of the winding process, based on the identification information of the electrode assembly.

10. The data tracking method of claim 9,
further comprising acquiring identification information of a housing in which the electrode assembly is accommodated,
wherein the identification information of the electrode assembly is acquired based on the identification information of the housing.

11. The data tracking method of claim 10,
further comprising retrieving data related to the manufacture of at least one of a battery cell, a battery module, and a battery pack including the electrode assembly or the housing, based on at least one of the identification information of the electrode assembly and the identification information of the housing.

12. The data tracking method of claim 9,
wherein the data associated with the identification information comprise at least one of a cut count value and a coordinate value of at least one electrode included in the electrode assembly.

13. The data tracking method of claim 12,
wherein the data associated with the identification information comprises at least one of coordinate data indicating the position of the electrode in each sub-process corresponding to at least one of the cut count value and the coordinate value, and process event data related to the electrode in each sub-process.

14. The data tracking method of claim 9,
wherein the data associated with the identification information comprises at least one of: process event data in the winding process, electrode roll map data in the winding process, lot identification information of the electrode or electrode sheet in the winding process, and data regarding defects in the electrode sheet.

15. The data tracking method of claim 9,
wherein the data associated with the identification information in the subsequent process of the winding process comprises
at least one of:
data regarding defects in the electrode assembly;
tray identification information of a tray on which the electrode assembly is loaded;
position data of a loading position of the electrode assembly in the tray; and
identification information of a housing or can in which the electrode assembly is accommodated.
